(19) United States
(12) Patent Application Publication
(10) Pub. No.: US 2006/0121935 A1
(43) Pub. Date: Jun. 8, 2006

(54) System, devices and methods using an indication of complementary access availability in measurement reports sent by mobile terminals

(75) Inventors: Lars Dalsgaard, Oulu (FI); Samuli Talvia, Lieto as (FI); Whui Mei Yeo, Salo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/291,100

(22) Filed: Nov. 29, 2005

Related U.S. Application Data
(60) Provisional application No. 60/631,680, filed on Nov. 29, 2004.

(51) Int. Cl. H04M 1/00

(52) U.S. Cl. 455/552.1

(57) ABSTRACT

Interconnected first and second radio access technology (RAT) systems simultaneously communicate with mobile terminals each capable of operating in both the first and second RAT systems. A given mobile terminal is capable of detecting it is within range of an access point of the second RAT while the terminal is in communication with an access point of the first RAT. It exchanges registration signals (412, 414) with the access point of the second RAT and only then does it provide an identification signal (430) indicative of registration therein to the access point of the first RAT. There it is used in determining whether to handover the terminal to the second RAT. Using this approach, there is no need for a complex measurement reporting system and, as another benefit, mobile terminals without dual-RAT capabilities are relieved of unnecessary radio measurements.

### CROSS-REFERENCE TO RELATED APPLICATION

This application claims the benefit of U.S. Provisional Patent Application No. 60/631,680 filed on Nov. 29, 2004.

### BACKGROUND OF THE INVENTION

1. Technical Field

The present invention relates to the field of mobile communications and, more particularly, to providing a user with a seamless transition between wireless networks using different radio access technologies. A particular embodiment is disclosed relating to interoperability between GSM cellular networks and WLAN networks. However, the invention is also applicable, but not restricted, to other cellular networks such as WCDMA and complementary access radio technologies such as Bluetooth. The detailed description which follows shows a GSM CS connection as an illustration.

2. Discussion of Related Art

This invention is a step in the direction of resolving interoperability issues between different wireless network architectures and radio access technologies (RATs) such as GSM and WLAN.

The success of cellular terminals has been due to the convenience factor of being able to communicate through voice without being limited by the length of the telephone cord. It is expected that mobile terminals of the near future would support a host of RATs to provide the end user with the best possible seamless experience, regardless of the RAT used.

By making available a seamless change between e.g. GSM and WLAN the user will be able to get the benefits of both systems without interrupts. One part of such a seamless 10 would be by using handovers (during dedicated mode calls) and Cell Change Orders (CCO) during e.g. packet switched connections. Normally such messages would be commanded based on measurement reports sent by the Mobile Station (MS) to the network on a regular basis based on information sent by the RAN to the mobile. Indication of the Complementary access AP availability in the repeated measurement report from the mobile to the RAN is a problem.

Currently there exists no standardized interoperability between 3GPP-standardized systems and complementary access systems (e.g., WLAN, Bluetooth, or the like).

Proposals on GERAN functionality have been made by the unlicensed mobile access (UMA) group. However, these proposals are not well defined in details and do not comply very well with the current understanding of the 3GPP specification. Besides that, the proposals including such measurements and measurement reporting will have a negative impact on MS functionality and power consumption and will even have an impact on power consumption for an MS not supporting the complementary access service.

### DISCLOSURE OF INVENTION

The idea of the present invention is that regardless of what type of complementary radio access technology is provided by the access point, e.g. WLAN or Bluetooth, the mobile terminal is able to report the availability of the cell without using any complex measurement reporting system, and that the presence of the complementary access system (e.g. WLAN) is only reported if it is accessible. This could e.g. mean that the MS has performed successful registration towards the system.

Keeping in mind the foregoing and without limiting the invention thereto, the specification which follows proposes a new and simple way for a complementary access 3GPP cellular-enabled mobile terminal to uniquely indicate by indexing, when sending measurement reports to the network, availability of a complementary access Access Point (AP). This is done, by letting the network inform the MS which index to use in the measurement reports (MRs). By indicating the availability of the complementary access network, this information may aid the network in making a decision on whether it should command the terminal to use a complementary access system instead of the current access system.

Non-prioritized advantages of the present invention include:
1. Easy method to indicate to the network that the mobile terminal is within coverage of a complementary access system that may give better coverage;
2. Idea is simple enough to be applied for any complementary access system regardless of the RAT;
3. No need to introduce new mobile-to-network messages—using existing spare bits in mobile-to-network messages (especially crucial for an MR which is already quite “full”);
4. No change to the way CS/PS HO/CCO currently works in the GSM system—network usually relies on the measured cells in measurement reports sent by the mobile terminal to decide if a cell change is needed;
5. Nothing UMA specific is broadcast in SI/PSI;
6. No changes to 3GPP TS 45.008 specification;
7. No special MS support in UMA case due to handling of Absolute Radio Frequency Channel Numbers (ARFCNs) outside supported bands;
8. No measurements done on dummy carriers;
9. Assuring that there will be no impact on MS's not supporting the UMA feature;
10. The proposal covers all measurement reporting methods;
11. Less updating on network side due to UMA;
12. This invention will reduce the complexity of handling UMA ARFCNs in measurement reports considerably on the MS side, compared with the current concept (see UMA stage 2 specification section 8.2).

### BRIEF DESCRIPTION OF THE DRAWINGS

FIG. 1 shows a mobile terminal in a radio access environment with more than one radio access technology (RAT) available for use, one of which is a complementary RAT and the other of which is a cellular RAT and using reporting of a complementary RAT to the cellular RAT, according to the invention.

FIG. 2(a) illustrates the current approach and FIG. 2(b) the inventive approach in correctly assuring UMA cell reporting in GERAN measurement reporting, for example.

FIG. 3 illustrates the logical blocks used in registration to UMA side and informing this to GERAN side. This includes sending the necessary UMA cell specific information to GERAN side to be used in the GERAN measurement reporting.

FIG. 4 shows an example of a mobile terminal, according to the present invention.

FIG. 5 shows an example of a base station or radio access network, according to the present invention.

FIG. 6 shows the URR REGISTER ACCEPT message content modified, according to the present invention.

FIG. 7 shows an example of a UMA point, according to the present invention, such as the UMA of FIG. 1

### BEST MODE FOR CARRYING OUT THE INVENTION

### LIST OF ABBREVIATIONS

AP: access point
UMA: Unlicensed Mobile Access
URR: UMA Radio Resource
WLAN: IEEE 802.11 Wideband Local Area Network
RAT: Radio Access Technology
CS: Circuit Switch
PS: Packet Switch
HO: Handover
CCO: Cell Change Order
MR: Measurement Report
PMR: Packet Measurement Report
PEMR: Packet Enhanced Measurement Report
EMR: Enhanced Measurement Report
UNC: UMA Network Controller
ARFCN: Absolute Radio Frequency Carrier Number
SI: System Information
PSI: Packet System Information
BSIC: Base Station Identity Code
UARFCN: UMA ARFCN
UTRA: Universal Terrestrial Radio Access

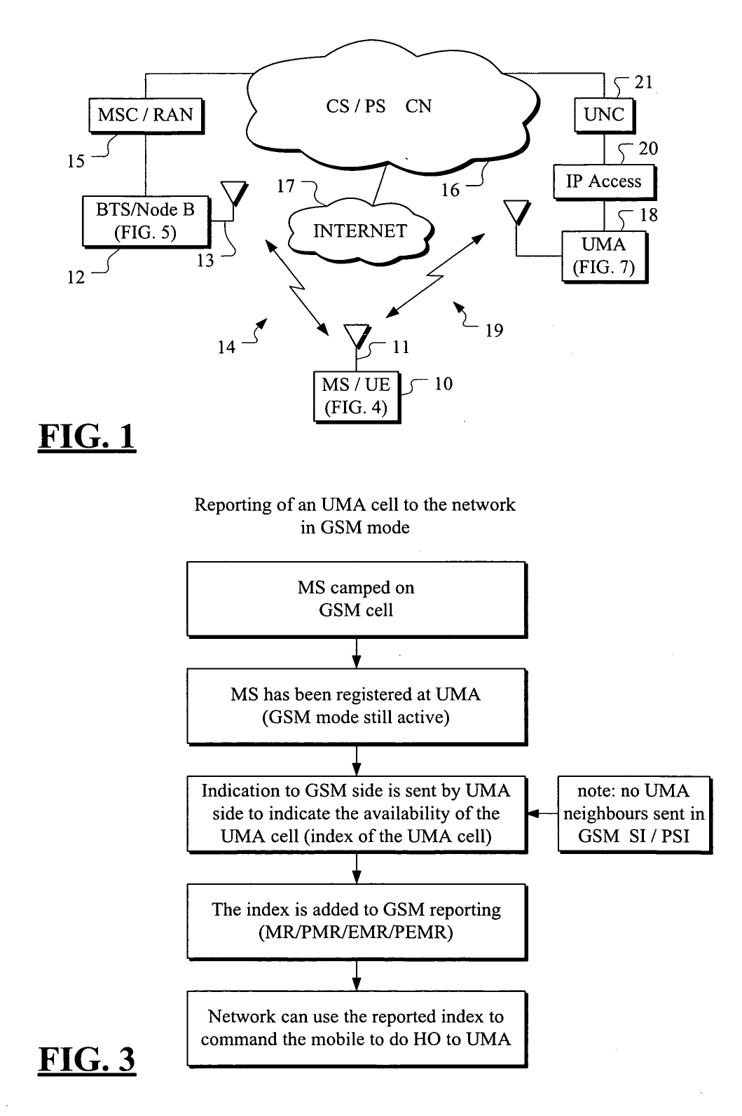

Referring to FIG. 1, a mobile station (MS)/User Equipment (UE) 10 is shown in radio communication with a base transceiver station (BTS)/Node B 12 over a wireless link 14. The BTS/Node B 12 is connected to a Mobile Switching Center (MSC)/Radio Access Network (RAN) 15 which is in turn further connected to circuit switched (CS) or packet switched (PS) mobile core network (CN) 16 or both. The Internet 17 is shown connected to this core network 16. In recent years, IEEE 802.11 based wireless networks (popularly known as Wi-Fi or WLAN) have become ubiquitous in homes, offices, and even cafes to provide broadband Internet access to users. Similar developments (WiMAX) exist for longer distances under the IEEE 802.16 Standard (Broadband Wireless Access) and the IEEE 802.20 Standard (mobile broadband wireless access). One such WiFi network is shown in FIG. 1 as providing for example, due to its short range, a low power radio link 19 by means of an unlicensed mobile access (UMA) point 18. It is simple and inexpensive to set up since it is an extension of the high speed landline Internet connection (via an IP Access point 20, UMA Network Controller (UNC) 21, and CN 16), so there is no need to invest in additional infrastructure and added expense is avoided. It provides the end user the convenience being connected to the Internet almost anywhere without being restricted to a location.

In the US and some developed East Asian countries, WLAN coverage is very good and in the US, it is even better than the cellular network coverage. If the end user of the terminal device 10 of FIG. 1 is using the cellular network 12, 15 for a voice conversation on his terminal but the cellular network coverage runs out and there exists a UMA 18 coverage nearby e.g., via WLAN, the voice call would have to be disconnected due to the current non-interoperability, i.e., to transfer a CS cellular connection to run over the WLAN. Similarly, if the end user is using the cellular network for data services, and if the end user experience is better over WLAN in a particular area, the terminal is currently not able to seamlessly transfer the connection from the cellular network to the WLAN without user intervention. It would also be desirable to make such a transfer in the opposite direction i.e., from the WLAN to the cellular network.

The invention is disclosed in the context of GSM CS domain but is not limited thereto. In that context, a broadcast channel is generally used to distribute common information to mobile terminals using the wireless system. This information is broadcast on a regular basis and includes a neighbor list that is used by the network to inform the mobile terminals about surrounding cells which can or may be used for mobility purposes. A MEASUREMENT REPORT (MR) message (See 3GPP TS 44.018 section 9.1.21 and section 10.5.2.20) is used for sending measurement results to the network during a CS connection. The report contains a list of measurements based on the current measurements of the neighbors and indirectly their synchronization status. The way a neighbor cell is referenced in the measurement report back to the RAN is by using its index as provided in the neighbor list previously sent by the network to the MS (See more details from TS 44.018 section 3.4.1.2). The index itself is not provided by the network to the UE in the neighbour list. Only the neighbour list is provided by the network. The index linked to a specific neighbour in the neighbour list is extracted by the UE itself. The MS also includes in the measurement report the BSIC information of the cell from which it has obtained its measurements.

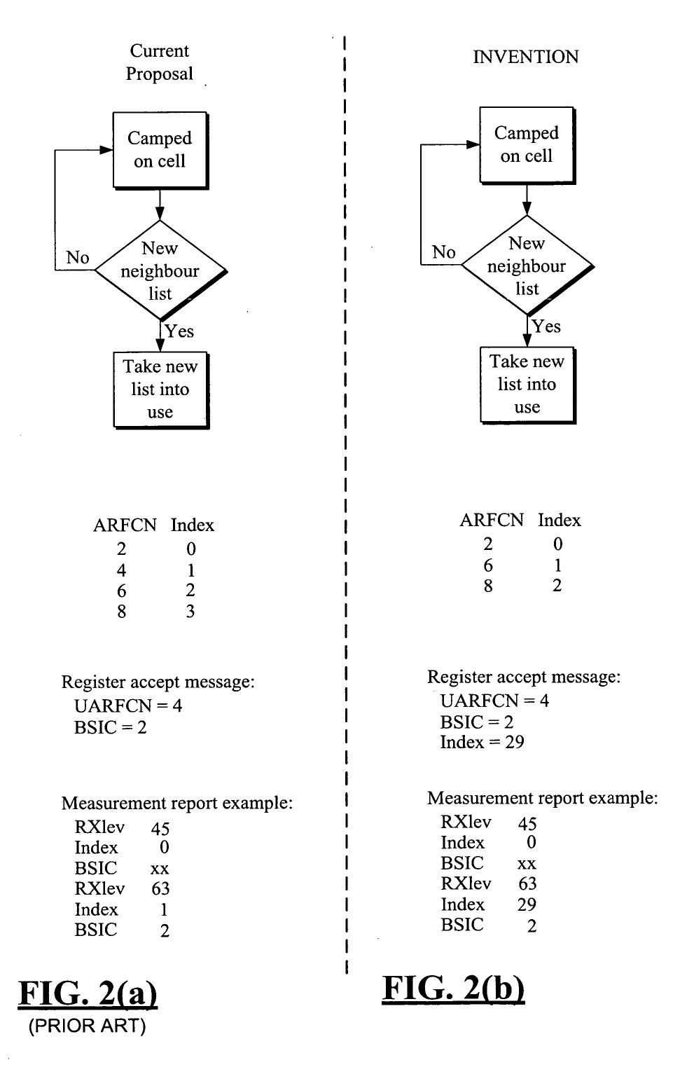

As shown in FIG. 2(a), when the radio access network broadcasts a broadcast channel it includes common information for distribution to mobile terminals over a radio downlink. As mentioned, this information is broadcast on a regular basis. The broadcast neighbor list is used by the network to inform the mobile terminals about surrounding cells which can/may be used for mobility purposes. It includes the neighbor list including the carrier ARFCNs in a coded format. The LTE decodes the list and sorts the list according to rules in the specifications. After the sorting of the neighbor list, each neighbor in the list will be uniquely identified by an index. The indexing starts from the first neighbor in the sorted list and that neighbor will be assigned Index 0. The mobile terminals take measurements of the surrounding cells and send measurement reports to the network. As also mentioned, these neighbor cells are given by the network in the broadcast neighbor list. The way that the mobile terminal indicates that measurements are available for a specific neighbor cell in the measurement report is done by using the index it provides as described above. Of course, another choice could have been to add the real ARFCN but that would be less efficient in terms of coding. Therefore, an indexing system is used to indicate the neighbor list. The general rule is such that the first neighbor in the neighbor list has index 0, the next index 1, and so on (see TS 44.018). This means that there is a one-to-one mapping between the members of the neighbor list and the indexes. This again means that in the measurement report, measurement results for the first neighbors in the neighbor list are reported using index 0 as an identifier of the cell. The network thereby knows that the measurement results are for neighbor cell 1 in the neighbor list. All of this is done in order to save bandwidth on the air interface.

For the UMA cell to be visible to the mobile stations, a simple way would be to assign a dummy carrier to the UMA cell and add this carrier as an entry in the current neighbor list broadcast by the network, so that it will work with the current measurement reporting mechanism. This is currently the method employed in the specifications. Such an approach is shown in FIG. 2(a) where a dummy carrier identified as ARFCN integer number “4” is listed in the broadcast list as having an index of 1 in the example shown. The register accept message from the UMA to the mobile terminal identifies the UARFCN with a BSIC which information is inserted in the measurement report sent back to the RAN along with the measurement report of the receive level. However, this method has a drawback that all mobile stations in the cell receiving the broadcast neighbor list will use this dummy carrier and perform measurements on this carrier. This includes also MSs not supporting the UMA inter-working feature. An MS supporting UMA inter-working will perform useless measurements on the dummy carrier until successful registration on the UMA side has been performed. An MS not supporting UMA inter-working will perform these useless measurements as long as it is camped in the cell. This invention removes this drawback.

The invention removes the need for using a dummy carrier entry in the broadcasted neighbor list. Instead this invention proposes to handle the measurement reporting and indexing in the neighbor list (and thereby the measurement reports sent by the MS to network) of the UMA cell, by adding an index field to the URR (UMA Radio Resource) Register Accept message in the following way:
1. When the MS has joined a complementary service AP it starts a Discovery and Registration procedure (details available from the UMA specification stage 3, section 6.1 and 6.2).

2. If the registration procedure is successful the UNC will provide the MS the Cell Identity and Location Area Identity and may provide the MS an ARFCN and BSIC (Base Station Identification Code) ID for the UMA cell (see URR REGISTER ACCEPT (UMA stage 3, section 10. 1.6), UMA CELL DESCRIPTION (UMA stage 3, section 11.2.13) and Cell Description in 3GPP TS 44.018 section 10.5.2.2)

3. This invention adds in the URR Registration Accept message a new field containing the index to be used by the MS in the measurement report as an index for the results of the UMA carrier. Note that even though the network provides the index, it still needs to provide the Base Station Identity Code (BCIC) to enable the MS and the network to distinguish the UMA cell from a GSM cell should a situation arise where the index of a GSM cell is the same as the given index. The RNC will have to “know” in advance which indexes are used for dummy indexes. The RNC will need to be able to map the dummy index to the UMA cell. In GSM it would mean that BSC converts/maps the index and BSIC couple into a global cell identifier (cell ID) which is further in the GSM network for uniquely identifying the reported cell (e.g., for handover purposes).

This proposal assures that there is no need for using a dummy carrier in the broadcast neighbor list as a placeholder for the UMA (Unlicensed Mobile Access) ARFCN (Absolute Radio Frequency Channel Number) for measurement report indexing purposes. This again assures that the MS does not make any useless measurements on this dummy carrier. Besides this, there is no need to make any changes to the current cell settings in the GERAN cell due to deployment of a UMA within the cell.

The idea is illustrated in FIG. 2(b) as compared to the current approach shown in FIG. 2(a). As illustrated in the current approach of FIG. 2(a), the network would broadcast the UMA specific ARFCN in the neighbor list used for mobility measurements (ARFCN 4). In the proposal of FIG. 2(b), according to the present invention, the UMA specific ARFCN is not broadcasted in the neighbor list. Instead this ARFCN is received during a successful registration procedure in the registration accept message. Included in this message is now added the Index as well. This index will be used by the mobile in the measurement reporting in the same way as the MS already uses indexing in the measurement reporting today. This is also illustrated in FIG. 2(b).

Thus, according to the present invention, it is not necessary to broadcast any dummy carrier in the neighbor list from the radio access network to the mobile terminals. As has been explained in connection with FIG. 2(b), the UMA is still using the “dummy” carrier integer number “4” but now also includes the index field from the register accept message. The UMA carrier is indexed in the measurement report using index 29. And due to the inclusion of the index in the register accept message the mobile terminal (and the network with foreknowledge of the meaning of “29”) now know which index to use in the measurement report for identifying the UMA cell without any need to broadcast a dummy carrier for indexing purposes. It also eliminates the need for all mobile terminals, even those that do not have dual-RAT capabilities, to monitor the carrier indicated by the radio access network, thus saving power in such devices.

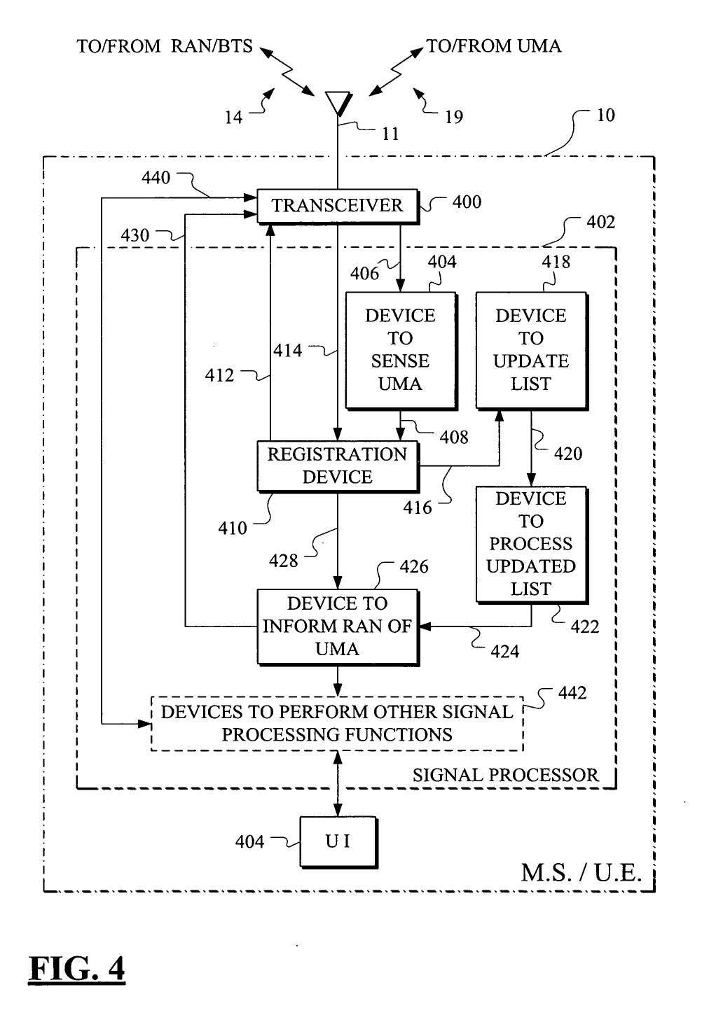

FIG. 3 illustrates the logical blocks of the flow. An MS 10 as shown in FIG. 1 is camped on the GSM side for instance and moves into the range of the UMA 18 and performs registration in the UMA 18 (this is done independently of GSM procedures). When the registration procedure is successfully performed, this is indicated to MS from the UMA network element (UNC) in a message including, among other things, the UARFCN, BSIC and, according to the invention, the Index of the UMA cell to be used in the GSM measurement reporting. The successful UMA registration is then indicated to the GSM network side over the radio link through normal measurement reporting. This is done by including the UMA cell BSIC using the Index given by the UMA network. The network 12, 15 can then use the Index and BSIC for uniquely identifying the UMA cell in the measurement report for mobility purposes.

A similar approach as presented in the idea above can be used for other measurement report types, like EMR, PMR, and PEMR.

This proposal is standardization specific. On the MS side this proposal assures that the MS can use already existing measurement procedures no matter if UMA inter-working is supported or not. It assures that an MS not supporting UMA, or supporting but not yet successfully registered, will not be affected by the fact that the network/cell supports GERAN UMA inter-working.

If the MS performs successful registration on the UMA side and the UMA cell needs to be added to the measurement report, this will be handled using the existing MS implementation.

On the other hand, it will have no impact on the MS and its measurement reporting in the cases where the MS do support UMA, but is not yet Registered on the UMA side.

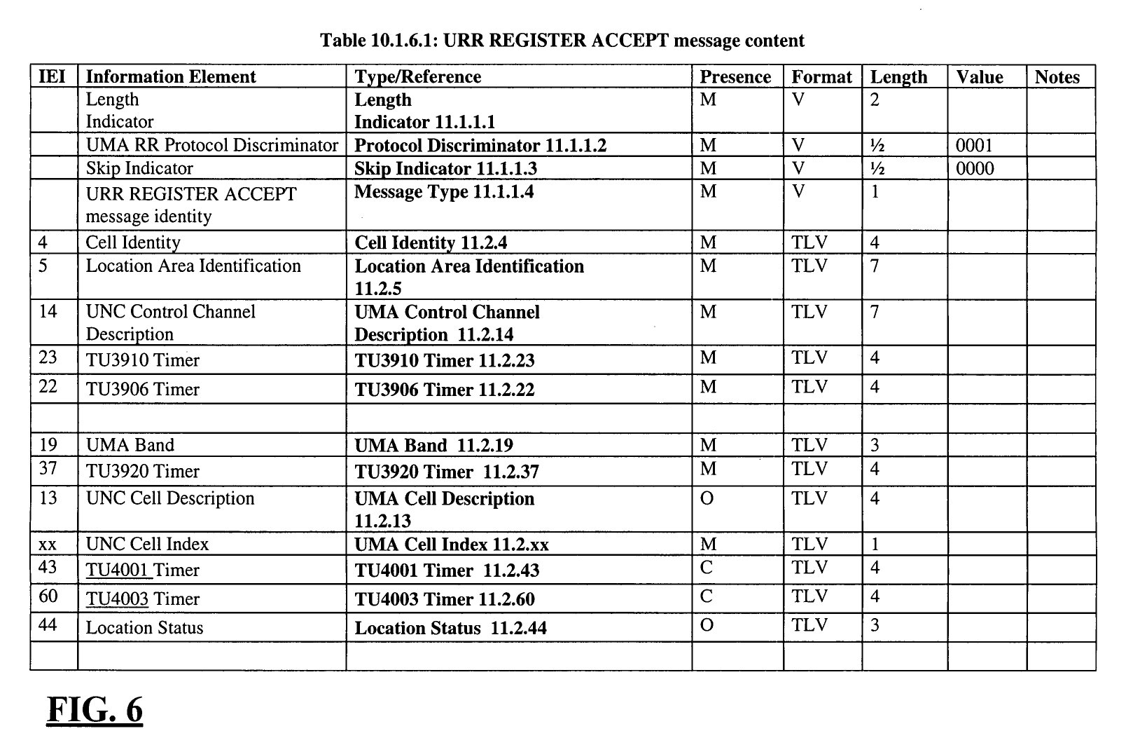

The invention could result for instance in a specification change that could look like that shown in FIG. 6 (modification of UMA stage 3 specification version r0_{—}0_{—}11):

10.1.6 URR Register Accept

The UNC (UMA Network Controller) 21 provides system information to the MS using this message. The content of this message is a collection of Information Elements (IEs) from system information 3 and 13 of the GERAN specifications plus some additions. The direction is from the UNC to the MS. The proposed added information element, called UNC Cell Index, is shown in FIG. 6. The field may for instance be one octet long of which 5 bits may be used to indicate to the MS the Index of the UMA cell to be used in measurement report. The coding of the UMA Cell Index field will be done according to section 10.5.2.20 in 3GPP TS 44.018 (see page 233).

This invention does not limit the way the Index field is used. This means that the Index field can be used in different ways depending on how this is specified in detail. Examples of usage could be:
1) The specification may state directly that the MS shall use a fixed index for referring to the UMA cell (e.g. the specification may state directly that the MS shall always refer to the UMA cell with index 29 (see FIG. 2(b): Index =29 in the Register accept message) or for instance with an index corresponding to the currently used neighbor list +1). Other variations can be envisioned.
2) The specification may state directly that the MS shall use a fixed index within the current neighbor list range and then indicate that the UMA cell is reported e.g. by use of the spare bit in the Measurement Result Information Element (See 3GPP TS 44.018, section 10.5.2.20)

FIG. 4 shows a mobile terminal 10 such as the mobile station or user equipment 10 of FIG. 1. The device 10 of FIG. 4 is illustrated with an antenna 11 connected to a transceiver 400 which is in turn connected to a signal processor 402. The signal processor is connected to a user interface 404 which may include a display and user input device such as a keyboard. Although the transceiver 400 is shown connected to a single antenna in FIG. 4, there could be two antennas instead of just one, one antenna for communication by radio link to and from the base transceiver station/Node B 12 and the other for communication by radio link to and from the UMA 18.

Some of the mobile functions illustrated in the embodiments described so far are illustrated within the signal processor 402 of FIG. 4. It should be understood that although the functions carried out by the signal processor 402 are illustrated as being carried out by devices, these devices correspond in reality to signal processing hardware and/or software which together carry out the functions carried out by the illustrated blocks. Such hardware/software may include a general purpose signal processor with a central processing unit connected to a data, address and control bus which is in turn connected to other devices such as memory devices, a clock, input/output ports, and other hardware which will be understood by those of skill in the art. A programming language can be used to provide coded instructions for storage in one or more of the memory devices which may include read only memory, random access memory, and other kinds of memory also known to those of skill in the art. Digital signal processing hardware and techniques may also be used to carry out the various functions of the terminal equipment 10 of FIG. 4. Such might include an integrated circuit. The devices show within the signal processor 402 of FIG. 4, will also be understood to constitute functional blocks which correspond to the functions carried out by such software/hardware combinations used, according to design choice.

Assuming that the terminal device 10 is in radio communication with the BTS/Node B 12 of FIG. 1 over the radio link 14, and is then moving into the vicinity of the radio environment provided by the UMA 18, the terminal device 10 may then sense via the antenna 11 and receiver function of the transceiver 400 the presence of the UMA radio environment by means of a device 404 within the signal processor 402. It does this by virtue of the fact that the antenna connected to the transceiver 400 provides a sensed signal from the UMA on a signal line 406 to the device 404 for sensing the UMA. Once the UMA is sensed, the device 404 may conduct internal checks to find out whether the signal strength is sufficient to sustain a connection and further, if the signal is strong enough, whether it will be better than the connection existing on the radio link 14 between the BTS/RAN 12 and the terminal 10. In that case, the device 404 would include one or more comparators or comparator functions that will be able to compare the sensed signal on the line 406 to a reference signal or a signal indicative of the strength of the radio link existing on the line 14. Besides signal strength, there could be other criteria that will be taken into account such as whether or not it will be advantageous to switch from the cellular system to the UMA due to cost issues. If the access to the UMA costs little or does not cost anything, then it may be decided by a decision function or device within device 404 to switch to the UMA even if the signal strength is not as good as that from the BTS/RAN so long as it is sufficient to sustain a connection. In other words, there could be many criteria used and which need not be discussed here for deciding whether the sensed signal on the line 406 is sufficient to initiate a registration process by sending a signal from the device 404 on a line 408 to a registration device 410. This registration device 410 is responsive to the signal on the line 408 for initiating a registration procedure between the terminal 10 and the UMA 18. It does this by sending and receiving a series of signals on signal lines 412, 414 to and from the UMA via the transceiver 400 and the antenna. This is done independently of the link 14 existing between the terminal 10 and the BTS/RAN 12. The discovery and registration procedure used can e.g. be according to the technical specification entitled “UMA Protocols (Stage 3) R1.0.2 (2004-11-05)” which is hereby incorporated by reference for background.

Part of the information exchanged between the registration device 410 and the UMA 18 includes information from the UMA to the registration device in which the UMA provides identification information identifying itself in a unique manner. This information is provided on the line 414 to the registration device 410. The registration device takes this information and provides it as a signal on a line 416 to a device 418 which serves to update an internal list which is shown is FIG. 2(b).

This list information may be signalled on a line 420 to another device 422 within the terminal 10 for processing the updated list and communicating the processed list information on a signal line 424 to a device 426 which serves to inform the BTS/Node B 12 of the existence of the registration in the UMA. The information transfer from the device 426 to the BTS/Node B can be initiated by the signal on the line 424 or for instance by a signal on a line 428 from the registration device 410, or both. In response, the device 426 sends the information as a signal on a line 430 to the transceiver 400 for being transmitted by the antenna on the radio link 14 to the BTS/Node B 12 of FIG. 1.

The BTS/Node B 12 can then use this information in deciding whether it should command the terminal to use the complimentary access system 18 of FIG. 1 instead of the current access system 12. If a handover command is to be communicated it can be sent from the BTS/Node B 12 on the radio link 14 to the terminal 10. Such a command would be received by the antenna 11 and the transceiver 400 and communicated on a bidirectional signal line 440 to other devices 442 within the signal processor in order to perform other signal processing functions necessary to make the handover from the BTS/Node B 12 to the UMA 18 in a seamless fashion. These details are not germane to the present invention and need not be disclosed herein.

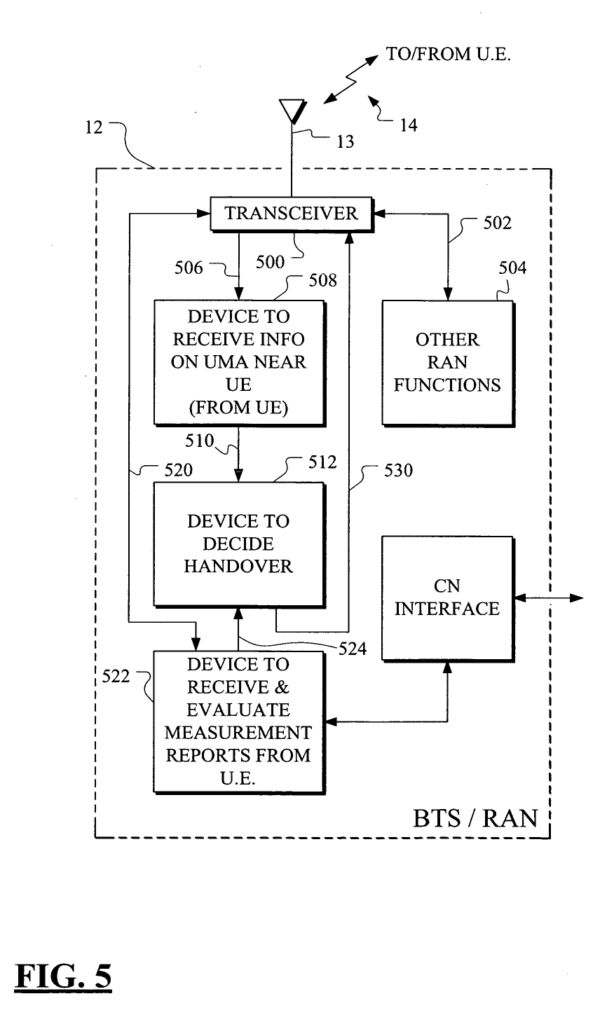

Referring now to FIG. 5, the BTS/Node B 12 of FIG. 1 is shown in more detail. It also includes an antenna 13 connected to a transceiver 500 which is in turn connected by signal lines to other devices within the BTS/Node B. As with the terminal 10 in FIG. 4, the blocks shown within the BTS/Node B 12 of FIG. 5 are illustrative of functional capabilities of the BTS/Node B which pertain with particularity to the invention disclosed and claimed herein. There will of course by many other functions carried out within the BTS/RAN that need not be illustrated here. In a manner similar to the terminal of FIG. 4, the functional blocks of FIG. 5 can be carried out in software, hardware (such as in an integrated circuit), or a combination of both. The design details are within the skill of the art and need not be disclosed here.

In any event, the radio link 14 of FIG. 1 is also shown in FIG. 5 communicating with the antenna 13 connected to the BTS/Node B which is in turn connected to the transceiver 500, as shown. As suggested above, the transceiver is connected by a bidirectional signal line 502 to other BTS/RAN functions 504 which need not be described herein but are merely indicated as shown.

The signal 430 of FIG. 4 that is communicated from the device 426 to inform the BTS/Node B for example of the existence of a registration of the terminal 10 in the UMA 18 is received by the antenna 13 over the radio link 14 and provided to the transceiver 500 which in turn provides the information as a signal on a line 506 to a device 508 that receives the information concerning the fact of the registration of the terminal 10 in the UMA 18. The device 508 may process this information and provide in response thereto a signal on a line 510 to a device 512 which decides on whether a handover from the BTS/Node B 12 to the UMA 18 is appropriate or not according to criteria which are decided upon within the functional block 512. In parallel with this decision making process, the BTS/Node B 12 may also be receiving measurement reports from the terminal 10 which are received by the transceiver 500 and provided as a signal on a line 520 to a device 522 which receives and evaluates the measurement reports from the terminal 10. As a result of signal processing associated with the evaluation of the measurement reports, the device 522 provides a signal on a line 524 indicative of the evaluation to the device 512 which uses the results of the processed reports in a decision making process in which a comparison is made between various criteria including the measurements and the fact that the device 10 has been registered in the UMA 18. If the decision is made to handover to the UMA 18, a handover command signal is provided on a line 530 to the transceiver 500 which in turn communicates the handover command decision to the terminal 10 over the link 14. A handover procedure can then be commenced, the details of which need not be disclosed herein as such implementation details are well known.

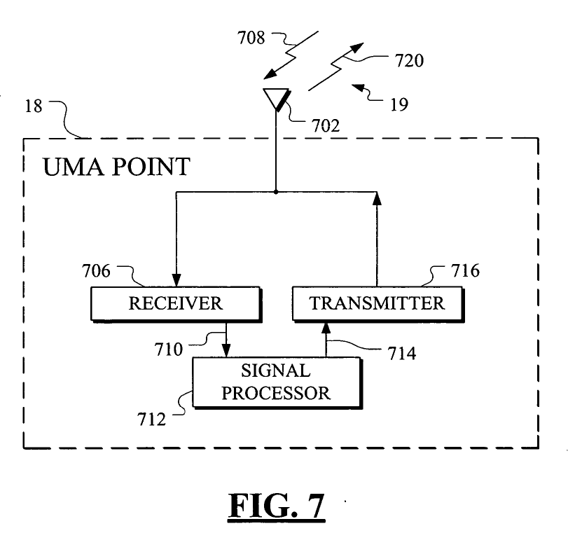

FIG. 7 shows an unlicensed mobile radio access point 18, according to the present invention. It includes an antenna 702 communicating by a radio interface 704 with a mobile terminal such as the mobile terminal 70 of FIG. 4. As explained previously, the mobile terminal of FIG. 4 can be equipped with technology capable of communicating both with a UMA point such as the UMA point 18 of FIG. 6 and a licensed radio access network such as a BTS of the GSM system or a 3GPP RAN or the like. Thus, the radio link 19 shown in FIG. 4 will be understood as equivalent to the radio interface of 19 of FIG. 7. The UMA point 18 of FIG. 7 includes a receiver 706 connected to the antenna 702 for receiving a signal from the antenna which has in turn received the same signal over the radio interface 19 on a link 708. The receiver is responsive thereto and provides an output signal on a line 710 to a signal processor 712 which processes the signal as described previously and as more fully described in the published UMA protocols (Stage 3) R1.0.2 (2004-11-05) entitled “Unlicensed Mobile Access (UMA); Protocols (Stage 3)” at Section 6.1.2 for instance or Section 6.2.2 or Section 6.3.2 or the like. As a result of the processing, an output signal is provided by the signal processor 712 on a line 714 to a transmitter 716 which is responsive thereto for providing said output signal to the antenna for transmission on the radio interface 19 for instance by the signal 720 as shown. In general, the UMA point 18 thus includes a receiver 706 for receiving a register request message by radio from a mobile terminal 10 and a signal processor 712 for processing the register request message. The processor then sends a register accept message by a radio signal 720 to the mobile terminal including an information element having an indexed identification of the unlicensed mobile access point such as shown by the index XX in FIG. 6 so as to facilitate identification of the unlicensed mobile access point 18 by a licensed mobile access point 12 via the mobile terminal. The licensed mobile access point 12 uses this information in evaluating a possible handover from the licensed access point 12 to the unlicensed access point 18, taking into account various factors including the measurement report from the particular mobile terminal 10, among others.

Although the invention has been shown and described with respect to a best mode embodiment thereof. It should be realized by those skilled in the art that the foregoing and various other changes, omissions and deletions in the form and detail thereof may be made therein without departing from the spirit and scope of this invention.

1. Method for use in a mobile communications terminal (10) capable of operating in both a first radio access technology system and in a second radio access technology system, comprising:
receiving a signal (19) from a first access point of said second radio access system while said terminal is in radio communication with a second access point of said first radio access technology system, for exchanging registration signals (412, 414) between said terminal and said second access point prior to reporting any radio measurements of said second access point to said first access point and for subsequently providing an identification signal (430) identifying said second access point to said first access point of said first radio access technology system for use in determining whether to handover said terminal to said second access point.

2. The method of claim 1, wherein said identification signal identifies said second access point by means of an index.

3. Mobile communications terminal (10) capable of operating in both a first radio access technology system and in a second radio access technology system, comprising:
a signal processor (402), responsive to a signal indicative of said terminal entering within range of a second access point of said second radio access technology system while said terminal is in communication with a first access point of said first radio access technology system, for exchanging registration signals (412, 414) between said terminal and said second access point prior to reporting any radio measurements of said second access point to said first access point and for subsequently providing to said first access point an identification signal (430) indicative of identification information of said second access point after registration of said terminal at said second access point is completed said identification information for use in determining whether to handover said terminal to said second access point.

4. The terminal of claim 3, wherein said identification signal identifies said second access point by means of an index.

5. Method for use in a first access point of a first radio access technology system while in radio communication with a mobile communications terminal (10) capable of operating in both said first radio access technology system and in a second radio access technology system at a same time, comprising:
receiving an initial measurement report with an identification of a second access point of said second radio access technology in a signal from said terminal indicative of a measurement and identification information of said second access point of said second radio access technology system with which said terminal has registered,
receiving other measurement reports from said terminal only after receipt of said initial measurement report,
deciding whether to handover said terminal from said first access point of said first radio access technology system to said second access point of said second radio access technology system based at least in part on said measurement report or reports, and
communicating a handover command to said terminal in case a decision is made to handover to said second access point of said second radio access technology system.

6. The method of claim 5, wherein said identification signal identifies said second access point of said second radio access technology system by means of an index.

7. Radio access point of a first radio access technology system communicating with a mobile communication terminal capable of operating in both said first radio access technology system and in a second radio access technology system, comprising:
means for receiving an initial measurement report with an identification of an access point of said second radio access technology system in a signal from said terminal indicative of a measurement and identification information of said access point of said second radio access technology system with which said terminal has registered;
means for receiving other measurement reports from said terminal only after receipt of said initial measurement report;
means for deciding whether to handover said terminal from said first radio access technology system to said second radio access technology system based at least in part on said measurement report or reports; and
means for communicating a handover command to said terminal in case a decision is made to handover said terminal to said second radio access technology system.

8. The radio access point of claim 7, wherein said identification signal identifies said access point of said second radio access technology system by means of an index.

9. A system comprising a first radio access technology system and a second radio access technology system interconnected by a circuit switched or packet switched network, or both, for simultaneously communicating with a mobile terminal capable of operating in both said first radio access technology system and in said second radio access technology system, wherein said mobile terminal comprising:
a signal processor (402), responsive to a signal indicative of said terminal entering within range of an access point of said second radio access technology system while said terminal is in communication with an access point of said first radio access technology system, for exchanging registration signals (412, 414) between said terminal and said access point of said second radio access technology system and for providing to said access point of said first radio access technology system an identification signal (430) indicative of identification information of said access point of said second radio access technology system after registration is completed to said access point of said second radio access technology system, said identification information for use by said first radio access technology system in determining whether to handover said terminal to said second radio access technology system; and wherein an access point of said first radio access technology system comprises:
means for receiving an identification signal from said terminal indicative of identification information of an access point of said second radio access technology system with which said terminal has registered;
means for deciding whether to handover said terminal from said first radio access technology system to said second radio access technology system; and
means for communicating a handover command to said terminal in case a decision is made to handover said terminal to said second radio access technology system.

10. The system of claim 9, wherein said identification signal identifies said access point of said second radio access technology system by means of indexing.

11. The system of claim 9, wherein said first radio access technology system is also for communicating with a mobile terminal only capable of operating in said first radio access technology system wherein a broadcast channel used by said first radio access technology system to distribute common information to mobile terminals on a regular basis includes a neighbor list to inform the mobile terminals about surrounding cells, and wherein said neighbor list includes an indexed list of frequencies without any dummy carrier listed for any measurement by any mobile terminal including said mobile terminal only capable of operating in said first radio access technology system.

12. Method for use in a communications system comprising both a first access point of a first radio access technology system and a second access point of a second radio access technology system, said method for reducing power consumed in a mobile terminal of said communications system accessing said first access point, said method comprising:
conducting radio measurements concerning said second access point if said mobile terminal is equipped with radio access technology according to said second radio access technology system,
reporting said radio measurements to said first access point only if said mobile terminal decides to report said radio measurements to said first access point, wherein
said radio measurements are for use in said first access point or in said first radio access technology system in determining whether to handover said mobile terminal to said second access point of second radio access technology system.

13. The method of claim 12, wherein said mobile terminal decides to report said measurement to said first access point if it becomes registered in said second radio access technology system via said second access point.

14. Apparatus for use in a communications system comprising both a first access point of a first radio access technology system and a second access point of a second radio access technology system, said system having reduced power consumption in a mobile terminal of said communications system accessing said first access point and reporting radio measurements of neighboring cells to said first access point, said apparatus comprising:
measurement means for conducting said radio measurements concerning said second access point of said mobile terminal is equipped with radio access technology according to said second radio access technology system; and
reporting means having said reduced power consumption by reporting said radio measurements to said first access point only if said mobile terminal decides to report said radio measurements to said first access point, wherein said radio measurements are for use in said first access point or in said first radio access technology system in determining whether to handover said mobile terminal to said second access point of said second radio access technology system.

15. The apparatus of claim 14, further comprising means for deciding to report said measurement to said first access point of said mobile terminal becomes registered in said second radio access technology system via said second access point.

16. Method for use in an unlicensed mobile radio access point, comprising:
receiving a register request message by radio from a mobile terminal,
processing said register request message, and
sending a register accept message by radio to said mobile terminal including an information element having an indexed identification of said unlicensed mobile access point so as to facilitate identification of said unlicensed mobile access point by a licensed mobile access point via said mobile terminal for use in evaluating a possible handover from said licensed access point to said unlicensed mobile access point.

17. Unlicensed mobile radio access point, comprising:
means for receiving a register request message by radio from a mobile terminal;
means for processing said register request message; and
means for sending a register accept message by radio to said mobile terminal including an information element having an indexed identification of said unlicensed mobile access point so as to facilitate identification of said unlicensed mobile access point by a licensed mobile access point via said mobile terminal for use in evaluating a possible handover from said licensed access point to said unlicensed access point.

18. Integrated circuit comprising means for carrying out the steps of claim 1 in said mobile communications terminal.

19. Integrated circuit comprising means for carrying out the steps of claim 5 in said first access point.

20. Integrated circuit comprising means for carrying out the steps of claim 16 in said unlicensed mobile radio access point.

21. Computer program comprising coded instructions for at least temporary storage on a computer readable medium for carrying out the steps of claim 1 in said mobile communications terminal.

22. Computer program comprising coded instructions for at least temporary storage on a computer readable medium for carrying out the steps of claim 5 in said first access point.

23. Computer program comprising coded instructions for at least temporary storage on a computer readable medium for carrying out the steps of claim 16 in said unlicensed mobile radio access point.

24. Data structure for at least temporary storage in an unlicensed mobile radio access point and in a mobile terminal during communication of a register accept message over a radio link from said unlicensed mobile radio access point to said mobile terminal, said data structure comprising an information element having an indexed identification of said unlicensed mobile access point so as to facilitate identification of said unlicensed mobile access point by a licensed mobile access point via said mobile terminal for use in evaluating a possible handover from said licensed access point to said unlicensed mobile access point.
